(19) United States
(12) Patent Application Publication
(10) Pub. No.: US 2007/0274548 A1
(43) Pub. Date: Nov. 29, 2007

(54) Multi-channel headphone

(75) Inventor: Ying-Shih Huang, Taoyuan (TW)

Correspondence Address: BROWDY AND NEIMARK, P.L.L.C.;624 NINTH STREET, NW, SUITE 300, WASHINGTON, DC, 20001-5303, US

(73) Assignee: Jetvox Acoustic Corp., Taoyuan City (TW)

(21) Appl. No.: 11/438,258

(22) Filed: May 23, 2006

(51) Int. Cl. H04R 5/02; H04R 25/00

(52) U.S. Cl. 381/309; 381/182; 381/376

(57) ABSTRACT

A multi-channel headphone includes a case adapted to be worn on user's ear and cover the whole ear, in which a middle speaker, a front speaker, rear speaker and a bass speaker are provided. The front speaker has a broadcasting portion facing a front side of an auricle of the ear and the rear speaker has a broadcasting portion facing a rear side of the auricle. The headphone provides a sound closing to the idea surround sound.

### BACKGROUND OF THE INVENTION

1. Field of the Invention

The present invention relates generally to a speaker, and more particularly to a multi-channel headphone to provide surround sound.

2. Description of the Related Art

FIG. 1 shows a conventional multi-channel headphone 10, which includes a case 11 with a front speaker 12, a middle speaker 13 and a rear speaker 14 arranged in parallel. The front and rear speakers 12 and 14 simulate the front and rear surround sounds. FIG. 2 shows another conventional multi-channel headphone 20, which also includes a case 21 with front, middle and rear speakers 22, 23 and 24. The different is the front and rear speakers 22 and 24 leaned outwards respectively, which means there are included angle between the normal orientation of the headphone 20 and the orientations of the front and rear speakers 22 and 24 respectively. In principle, the front speaker should be in front of user to provide sound waves to the face of user and the rear should be behind user to provide sound waves to the back of user. But these conventional headphones have the front and rear speakers with the same distance to the user. As shown in FIG. 3, for an idea surround sound, the front speaker should be located at the front of user in a range between 50 degrees and 70 degrees, and the rear speaker should be located at the back of user in a range between 50 degrees and 70 degrees, except that the left and right speakers are designated to provide sound. The conventional multi-channel headphone only provides the specific locations of the front and rear speakers but the sound waves' directions, so that the conventional multi-channel headphone can not provide a sound closing to the idea surround sound.

### SUMMARY OF THE INVENTION

The primary objective of the present invention is to provide a multi-channel headphone to provide a sound closing to the idea surround sound.

According to the objective of the present invention, a multi-channel headphone comprises a case adapted to be worn on user's ear and cover the whole ear, in which a middle speaker, a front speaker, rear speaker and a bass speaker are provided. The front speaker has a broadcasting portion facing a front side of an auricle of the ear and the rear speaker has a broadcasting portion facing a rear side of the auricle.

### BRIEF DESCRIPTION OF THE DRAWINGS

FIG. 1 is a sketch diagram of the conventional multi-channel headphone;

FIG. 2 is a sketch diagram of another conventional multi-channel headphone;

FIG. 3 is a sketch diagram of the arrange of an idea surround sound;

FIG. 4 is a sketch diagram of a preferred embodiment of the present invention; and

FIG. 5 is a sectional view along 5-5 line of FIG. 4.

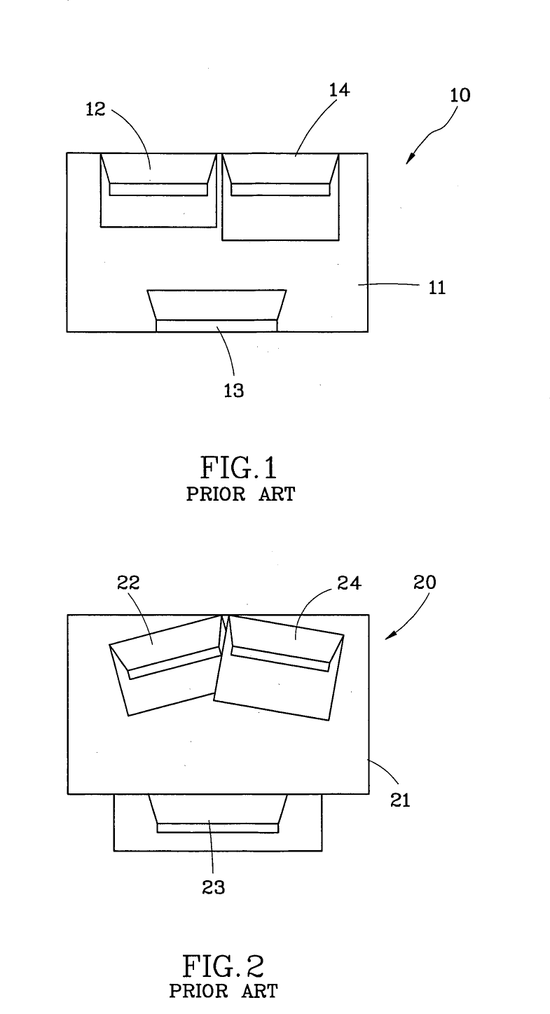

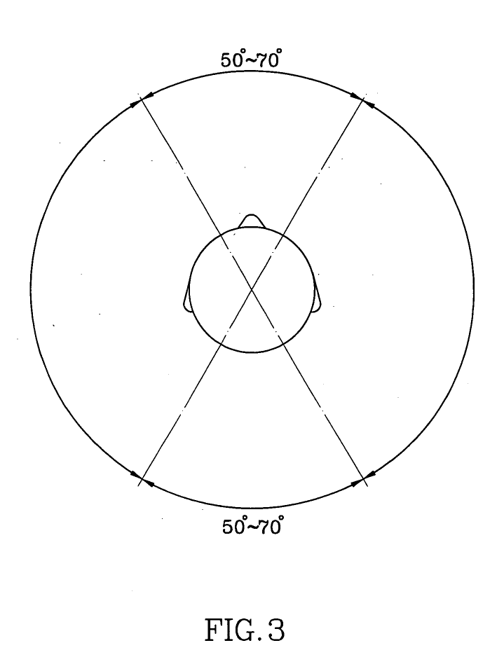

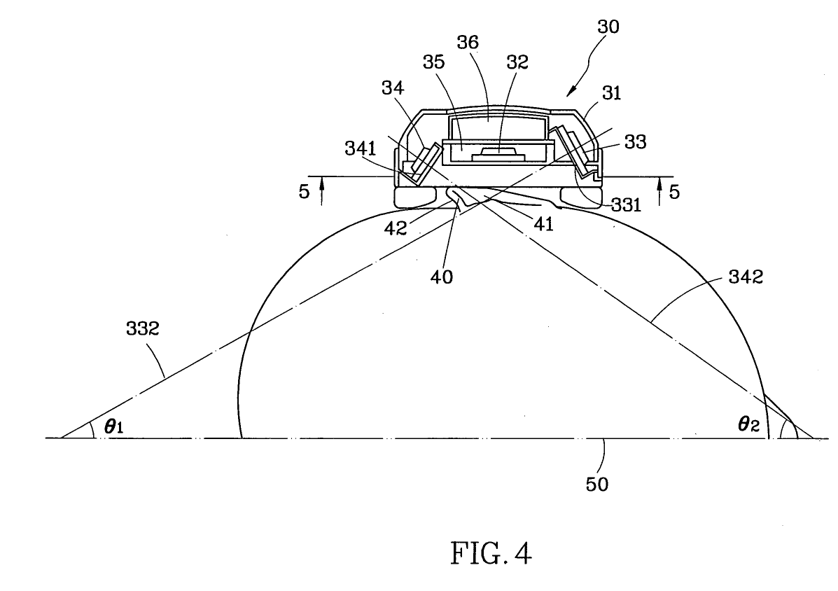

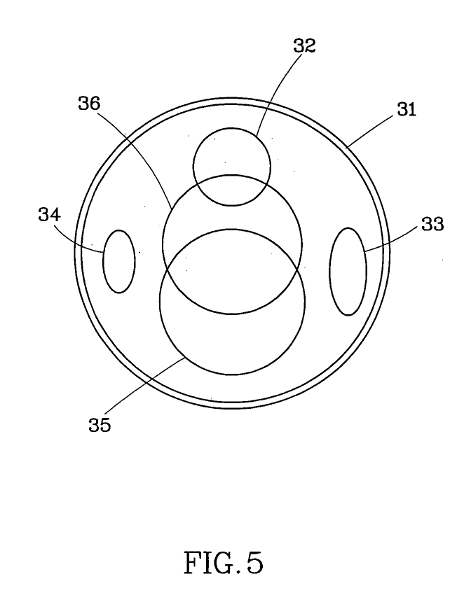

### DETAILED DESCRIPTION OF THE INVENTION

As shown in FIG. 5 and FIG. 5, a multi-channel headphone of the preferred embodiment of the present invention has two phone units, each of which includes:

A case 31 is worn on user's ear to cover the whole ear for sound barrier.

A middle speaker 32 is provided in the case 31 associated to a middle portion of user's ear.

A front speaker 33 is provided in the case 31 associated to a front portion of user's ear. The front speaker 33 has a broadcasting portion 331 facing a front side of an auricle of the ear. An angle θ1 between a normal axis 332 of the broadcasting portion 331 of the front speaker 33 and a middle sagittal plane 50 of the user, which is a virtual vertical plane through user's nose to divide user's body into a right portion and a left portion, is less than 35 degrees.

A rear speaker 34 is provided in the case 31 associated to a front portion of user's ear. The rear speaker 34 has a broadcasting portion 341 facing a rear side of the auricle of the ear. An angle θ2 between a normal axis 342 of the broadcasting portion 341 of the rear speaker 34 and the middle sagittal plane 50 of the user is less than 35 degrees.

A bass speaker 35 is provided in the case 31 under the middle speaker 32.

The present invention provides the front and rear speakers 33 and 34 with predetermined broadcasting angles to approach the idea surround sound.

The present invention may provide a vibrator 36 behind the middle speaker 32 to assist the bass speaker 35. For example, the vibrator 36 will work when the bass frequency is less than 120 Hz, or when the bass speaker's 35 output is greater than a predetermined value. The vibrator 36 does not work until the volume is greater than a predetermined value and the bass frequency is less than a predetermined value that would make the sound more stereo.

What is claimed is:

1. A multi-channel headphone, comprising:
a case adapted to be worn on user's ear and cover the whole ear;
a middle speaker provided in the case associated to a middle portion of the ear;
a front speaker provided in the case associated to a front portion of the ear;
a rear speaker provided in the case associated to a rear portion of the ear; and
a bass speaker provided in the case;
the front speaker having a broadcasting portion facing a front side of an auricle of the ear and the rear speaker having a broadcasting portion facing a rear side of the auricle.

2. The multi-channel headphone as defined in claim 1, wherein an angle between a normal axis of the broadcasting portion of the front speaker and a middle sagittal plane of the user, which is a virtual vertical plane through user's nose to divide user's body into a right portion and a left portion, is less than 35 degrees.

3. The multi-channel headphone as defined in claim 1, further comprising a vibrator provided in the case.

4. The multi-channel headphone as defined in claim 1, wherein the vibrator works when a bass frequency is less than 120 Hz.

5. The multi-channel headphone as defined in claim 1, wherein the vibrator works when a volume of the headphone is greater than a predetermined value.
